(19) United States
(12) Patent Application Publication
(10) Pub. No.: US 2009/0089475 A1
(43) Pub. Date: Apr. 2, 2009

(54) Low latency interface between device driver and network interface card

(76) Inventors: Nagabhushan Chitlur, Portland, OR (US); Linda Rankin, Portland, OR (US); Paul M. Stillwell, JR., Aloha, OR (US); Dennis Bradford, Portland, OR (US)

Correspondence Address: Caven & Aghevli LLC;c/o CPA Global, P.O. BOX 52050, MINNEAPOLIS, MN, 55402, US

(21) Appl. No.: 11/906,098

(22) Filed: Sep. 28, 2007

(51) Int. Cl. G06F 13/14

(52) U.S. Cl. 710/305

(57) ABSTRACT

Methods and apparatus relating to a low latency interface between a device driver and a network interface device are described. In one embodiment, a network interface card (NIC) and a processor may be coupled through a coherent interconnection, e.g., to allow for coherent communication of data between buffers in the NIC and the processor. Other embodiments are also disclosed.

### BACKGROUND

The present disclosure generally relates to the field of electronics. More particularly, an embodiment of the invention generally relates to a low latency interface between a device driver and a network interface card (NIC).

Networking has become an integral part of computer systems. However, some network input/output (I/O) acceleration technologies are generally targeted towards achieving improved performance for relatively large packet sizes. For example, direct memory access (DMA) may be used to accelerate I/O operations. To perform DMA a number of descriptor-related operations may need to be performed prior to the actual data transfer. The additional operations may however increase the overhead associated with DMA operations, especially for relatively smaller packet sizes. Accordingly, some network acceleration technologies may be inefficient for transfer of relatively small packets.

### BRIEF DESCRIPTION OF THE DRAWINGS

The detailed description is provided with reference to the accompanying figures. The use of the same reference numbers in different figures may indicate similar items.

FIG. 1 illustrates various components of an embodiment of a networking environment, which may be utilized to implement various embodiments discussed herein.

FIG. 2 illustrates an overview of a communication system, according to an embodiment.

FIGS. 3-4 illustrate flow diagram of methods according to some embodiments.

FIG. 5 illustrates a block diagram of an embodiment of a computing system, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some of the embodiments discussed herein may provide a low latency and/or high bandwidth interface between a device driver and a network interface device (such as a NIC). Some techniques may increase performance for large and small packet sizes (e.g., for packets between about 64 and 512 bytes in size) by eliminating the DMA transfer overhead for descriptors and/or small payloads (e.g., payloads in the range of about 64 bytes and 640 bytes). For transmit operation, an embodiment may provide a hardware interface that allows the network device driver to directly push data to a NIC device, which may in turn eliminate the need for the NIC to fetch the associated descriptors/payload from the system/main memory. On the receive side, an embodiment may use a cache coherent “receive data buffer” to store packets arriving from the wire (e.g., a computer network). This receive data buffer may be implemented on the NIC and may be directly accessible by a processor, which may in turn allow the processor to obtain access to received packets before they reach the system memory. This reduces latency and/or improves bandwidth, as well as forms a basis to reduce overhead (e.g., associated with copying data and/or descriptor updating) on the receive side.

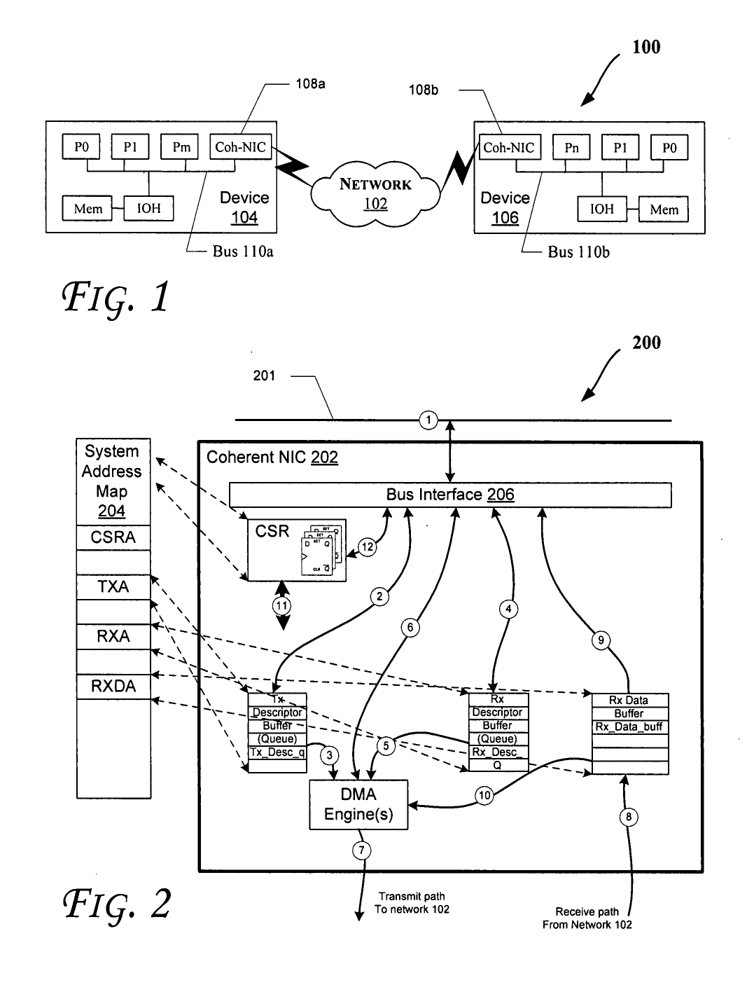

FIG. 1 illustrates various components of an embodiment of a networking environment 100, which may be utilized to implement various embodiments discussed herein. The environment 100 may include a network 102 to enable communication between various devices such as devices 104 and 106. The devices 104 and 106 may be any type of a computing device including, for example, a server computer, a desktop computer (e.g., a workstation or a desktop computer), a laptop (or notebook) computer, a rack-mounted computing system, etc.

The network 102 may be any type of a computer network including an intranet, the Internet, and/or combinations thereof. The devices 104-106 may be coupled to the network 102 through wired and/or wireless connections. Hence, the network 102 may be a wired and/or wireless network. For example, a wireless access point may be coupled to the network 102 to enable wireless-capable devices to communicate with the network 102. In one embodiment, the wireless access point may include traffic management capabilities. Also, data communicated between the devices 104-106 may be encrypted (or cryptographically secured), e.g., to limit unauthorized access.

The network 102 may utilize any type of communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire. Moreover, wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) or external network interface devices (e.g., having a separate physical enclosure and/or power supply than the computing system to which it is coupled) such as a network interface card (NIC).

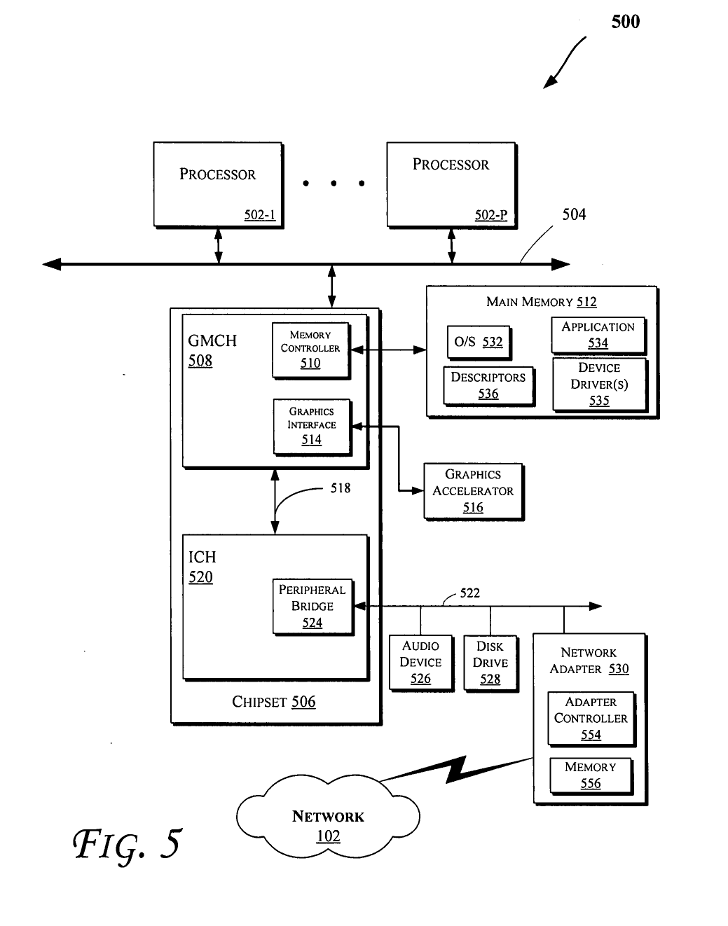

As illustrated in FIG. 1, each of the devices 104-106 may include one or more processors (e.g., P0-Pm and P0-Pn), an I/O hub (IOH), a memory (such as a system/main memory), and/or a coherent NIC (e.g., 108a or 108b). A bus (or interconnection) (e.g., 10a or 110b) may couple one or more of the aforementioned components. In an embodiment, the coherent attached NIC device (e.g., 108a or 108b) is directly coupled to a coherent system interconnect (e.g., 110a or 110b) and is a full participant of the cache coherency protocol of processor memory complex. Two nodes (e.g., devices 104 and 106) connected via coherent NICs are shown in FIG. 1, however, more than two nodes may participate in such a configuration. In an embodiment, the buses 110a and 110b may be multi-drop front side buses (FSBs) coupled to the system/main memory. In various embodiments, the interconnect/bus used may be an FSB, a common system interface (CSI), another coherent interconnect, or combinations thereof. Further, the IOH may include a memory controller (as will be further discussed with reference to FIG. 5). Furthermore, similar optimizations may be used in systems with point-to-point interfaces between the processors (with or without integrated memory controllers) as will be further discussed with reference to FIG. 5.

In some embodiments, direct access to the coherent NIC (e.g., NICs 108a or 108b) is achieved by mapping accessible NIC resources (e.g., accessible via software such a device driver) to cacheable memory. A combination of the NIC being on the coherent interconnect along with the memory mapped apertures allow the NIC hardware buffers to be directly mapped into system memory, creating an efficient interface from the processor to coherent NIC device. This coherent NIC interface may enable the processor to directly push NIC commands (e.g., descriptors) and push/pull data to/from the NIC without having to use the main system memory as an intermediary in some embodiments. On the transmit side this interface may enable an efficient mechanism in which data may be pushed directly to the NIC also referred to as “immediate data” allowing quick transfer of data without incurring latency associated with transmission of DMA descriptors. On the receive side the memory mapped aperture interface may allow the processor to directly read the receive packet buffer on the NIC.

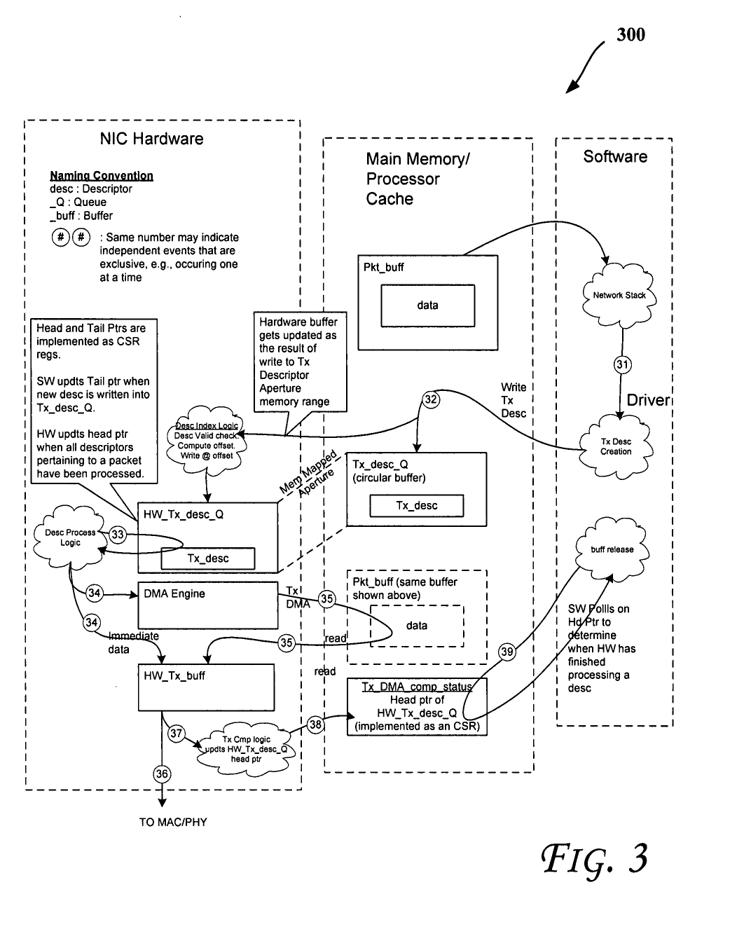

FIG. 2 illustrates an overview of a communication system 200, according to an embodiment. The system 200 may include a coherent bus 201 (e.g., such as buses 108a or 108b discussed with reference to FIG. 1) that is coupled to a coherent NIC 202. Various data stored on the NIC 202 may be mapped to a system address map 204 such as shown in FIG. 2. The NIC 202 may include a bus interface 206 to enable communication between the bus 201 and NIC components.

In an embodiment, a transmit descriptor aperture (TXA) may be defined as a contiguous memory region in system address map 204 that is backed by hardware buffers on the NIC device thereby allowing software (such as a device driver) to directly access them via the use of system memory addresses. This memory region may or may not be backed by host system memory. Each address within this range may have a corresponding location in the hardware transmit descriptor buffer. In some embodiments, the NIC hardware buffers may be implemented as circular queues with head and tail pointers implemented as registers. For example, the Tx (transmit) tail pointer may indicate the last valid entry in this buffer and the Tx head pointer may point to the current entry to be processed. In one embodiment, software updates the tail pointer when a valid descriptor has been written to the NIC device. Software may also poll on the Tx head pointer to determine if the NIC hardware has finished processing a descriptor.

As shown in FIG. 2, the NIC 202 may include one or more registers such as control and status registers (CSRs) that are mapped to various locations in a cacheable memory, such as within the illustrated system address map 204. The NIC 202 may also include a Tx descriptor buffer, a Rx (receive) descriptor buffer, and a Rx data buffer. One or more DMA engines within the NIC 202 may also be provided to perform DMA operations to move data to/from memory/NIC in accordance with descriptors.

Referring to FIG. 2, item 1 is a coherent system interconnect (e.g., FSB, CSI, etc.). Item 2 refers to a coherent Tx Descriptor path which may allow a processor (e.g., coupled to the bus 201) to directly write data into the Tx Descriptor buffer. Item 3 refers to a Tx DMA descriptor read path which may allow the DMA engine to read Tx descriptor for processing. Item 4 refers to a coherent Rx Descriptor path, which may allow a processor (e.g., coupled to the bus 201) to directly write data into the Rx Descriptor buffer. Item 5 refers to a Rx DMA descriptor read path, which may allow a DMA engine to read Rx descriptor for processing. Item 6 refers to a DMA request/response path, which may allow a DMA engine to issue bus specific commands directly on the coherent system interconnect/bus. Item 7 refers to a network Transmit path from the coherent NIC to the network. Item 8 refers to a network Receive path from network 102 to the receive data buffer. Item 9 refers to a coherent Snoop/Read path from Rx data buffer, which may allow a processor (e.g., coupled to the bus 201) to directly read data stored in the Rx data buffer, e.g., rather than having to go through a system memory first. Item 10 refers to a Rx data buffer DMA read path, which may allow a DMA engine to read data directly from the Rx data buffer on the NIC. This allows the processor (or CPU (Central Processing Unit)) to get access to the received packets before they are moved to system memory. The proposed Rx data buffer mechanism thus enables a very efficient method whereby the CPU may parse the packet contents while still in the NIC hardware buffer and move the received packet to its final destination with just one copy from the NIC data buffer to the final (e.g., application) data buffer in system memory. Item 11 refers to a CSR internal path which may fan out to/from the control status registers (CSRs) in the coherent NIC. Item 12 refers to a coherent CSR path which may allow a processor (e.g., coupled to the bus 201) to read/write NIC registers in one embodiment.

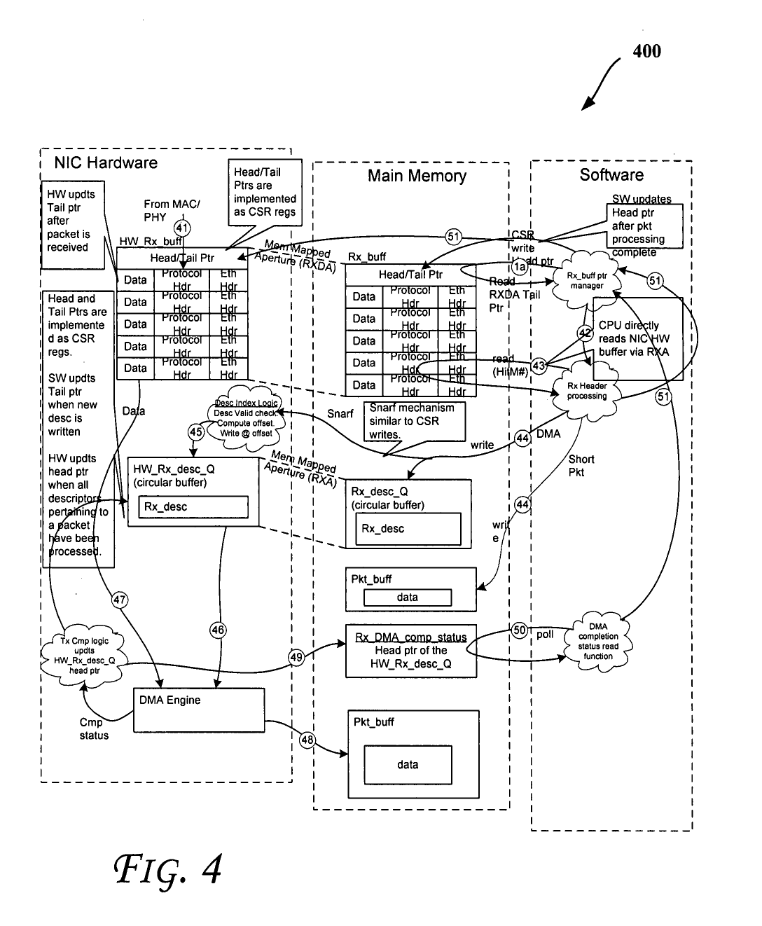

FIG. 3 illustrates a flow diagram 300 for transmit packet flow, in accordance with an embodiment. As shown in FIG. 3, at an operation 31, software (e.g., a device driver) receives a request to send a network packet (e.g., from a network stack) and creates the appropriate transmit descriptor (Tx_desc). The information in the Tx_desc may be used by the hardware to move data from a source location to destination location. The source and destination locations may be hardware local buffers or main memory. The transmit descriptors are then written to a memory location in the Transmit descriptor aperture (TXA) such as discussed with reference to FIG. 2. The Tx_desc may represent a DMA descriptor or an “immediate” descriptor. An “immediate” descriptor is generally a descriptor in which the data to be transmitted is also pushed into the TXA after the descriptor. This may eliminate the need for the NIC to read from memory to obtain the data in the packet.

At an operation 32, software updates the Tx Tail pointer (so these transactions become globally observable to the NIC). The mechanism used to update the NIC buffer may be implementation dependent, e.g., it may be via a snarfing mechanism, which generally refers to the NIC observing the transaction to the TXA memory range and updating its buffer, or it may be implemented such that the NIC is the true destination of that transactions. In either case, the NIC hardware transmit descriptor buffer is updated with the descriptor information; thus, the descriptors are transferred from the driver to hardware directly without using system memory as an intermediary. The hardware and software may implement head and tail pointers for the NIC transmit descriptor buffer to ensure that valid descriptors are processed by hardware. The aforementioned embodiment pushes the descriptors (and data in the case of immediate data, for example) to the NIC, rather than some current techniques that rely on the NIC pulling the descriptors.

At an operation 33, the NIC hardware processes the descriptor pointed to by the head pointer. The hardware may look at bits in the command field of the descriptor to identify the type of descriptor, e.g., DMA memory to local hardware buffer, immediate data packet, memory to memory copy descriptor, etc., and then performs the appropriate action. At an operation 34 (e.g., immediate data descriptor), if the descriptor is a “immediate data” descriptor, then the NIC hardware does not need to setup a DMA and the data is directly copied from the transmit descriptor buffer to a hardware transmit buffer.

At operations 34 and 35 (e.g., DMA descriptor), if the descriptor requires setting up a DMA, the NIC hardware sets the appropriate registers to initiate the DMA. The DMA engine reads data from the system memory into the hardware transmit buffer. At an operation 36, the data in the hardware transmit buffer is sent out on the network (e.g., network 102). At an operation 37, the Tx Head pointer is updated to indicate that a descriptor has been successfully processed. At an operation 38, the Tx Head pointer update event is made globally observable by either explicitly performing a main memory write or via an invalidation to the cache line containing the Head pointer. Either mechanism indicates to the software that the pointer has changed. Accordingly, contrary to some current techniques that may cause a cache line eviction of a line that may be in use by the software, some of the embodiments described herein may cause a cache line eviction wherein the cache line may be being updated by system software, thus the impact of the cache line eviction is minimized. At an operation 39, software may poll the Tx Head pointer and once the “write” or the “invalidation” is observed the coherency protocol may guarantee that the new value is observed by the software.

FIG. 4 illustrates a flow diagram 400 for receive packet flow, in accordance with an embodiment. In an embodiment, the flow shown in FIG. 4 may be referred to as Receive Data Aperture (RXDA). The RXDA may be a contiguous memory region in the system address map that is backed by a hardware buffer of equal size (see, e.g., FIG. 3). Each address in this region may be directly accessed by the processor via the use of regular system memory addresses. This memory region may or may not be backed by host system memory. This aperture holds the data received from the network 102 in an embodiment. The hardware may implement head and tail pointers to indicate valid packets in this buffer. For example, the Rx Tail pointer indicates the last address containing a valid packet. The Rx Head pointer points to the next packet to be processed. Hardware updates the Rx Tail pointer when a new packet arrives and the software polls on this pointer to determine if a new packet has arrived. The software may also update the Rx Head pointer once it is done processing the packet. Once software is aware of a new packet it directly reads the packet header from the NIC hardware receive buffer (HW_Rx_buff) via the RXDA and may process it before the packet is moved to system memory. This may allow for a flexible and efficient receive side architecture that enables the processor to route the received packets directly from the NIC hardware buffer to the final destination without having to go through a intermediate buffer in system memory.

At an operation 41, the packets arriving from the network (e.g., network 102) are stored in the NIC receive buffer (HW_Rx_buff). Software sees this buffer as a memory mapped buffer called Rx data buffer. For every received packet the Rx Tail pointer of the buffer is updated by the NIC hardware. Accordingly, contrary to some current techniques that transfer received packets into system memory via DMA based on a pre-posted descriptor that it has fetched prior to a packet arriving, the operation 41 does not require a transfer into system memory.

At an operation 42, software polls the Rx Tail pointer CSR register to determine if a packet has arrived. If the pointer indicates that a packet has arrived then the software begins to process the packet, as opposed to some current techniques that may utilize an interrupt to indicate arrival of a packet.

At an operation 43, software reads the Rx data buffer just as if it were in the main system memory. The hardware observes the read to the Rx data buffer and responds with appropriate response providing the data. At an operation 44 (e.g., a packet with immediate data), if the device driver performs the receive header processing and determines that the received packet does not require a DMA transfer, the driver reads the required data from the Rx data buffer and write to the memory directly. There is no DMA descriptor generated for such a transfer which increases efficiency.

At operations 44 and 45 (e.g., a packet requiring DMA), the device driver performs the receive header processing and creates a receive descriptor “Rx_desc” and writes it to the “Rx_desc_Q” via the RXA. The NIC hardware observes the transaction to the RXA and updates its local HW_Rx_desc_Q appropriately. In this manner the descriptors are transferred from the software to the hardware without the hardware having to explicitly read the descriptors.

At an operation 46 (e.g., a packet requiring DMA), the receive descriptor pointed to by the head pointer is used to initialize the DMA engine. At operation 47, 48 (e.g., a packet requiring DMA), if the Rx_desc requires data to be moved from local HW_Rx_buff to memory, the DMA engine reads the appropriate data from the Rx_buff and writes it to the memory address specified by the Dest_addr field in the Rx_desc.

At an operation 49 (e.g., a packet requiring DMA), once the DMA has completed the head pointer of the Rx_desc_Q is updated to indicate that the descriptor has been successfully processed. At an operation 50 (e.g., a packet requiring DMA), the driver polls the head pointer of the Rx_desc_Q to determine which descriptors have been processed. At an operation 51, ones the packet has been processed, the software updates the Rx Head pointer of the Rx data buffer so that the hardware may reuse the buffer locations occupied by the data.

In some embodiments, the transmit/receive mechanisms discussed herein may leverage from the NIC being on a coherent interconnect, e.g., allowing the processor to obtain efficient access to the NIC resources. Accordingly, at least some of the described mechanisms may be applied to achieve interconnects (such as those used in clusters and blade environments) that may require low latency for small packets but at the same time may require high throughput, e.g., using DMA engines for larger packets (for example, achieved under software control in one embodiment). In one embodiment, a method on the transmit side pushes the transmit descriptors from memory (cache or system memory) to the NIC, obviating a fetch of the descriptor by the NIC.

In an embodiment, a method on the receive side may read the packet data directly from the NIC (e.g., prior to any DMA) enabling system to efficiently move the data to the final destination (may copy the data or DMA in some embodiments). This feature enables receive operations without customary copying of data based on descriptors, etc., since the system may move the data directly into a users buffer via DMA or utilizing processor cycles to copy the data. Copying the data using processor cycles may be more efficient for certain packet sizes (e.g., smaller packets than for example 512 bytes) than setting up a DMA, thus improving I/O performance.

Some of the embodiments discussed herein may be implemented in a processor, memory controller, or it may be stand alone component. Also, such embodiments may enable the building of low cost and/or high performance interconnects for cluster computers. As discussed herein, low latency for small packets may be achieved since the descriptor and/or the packet payload (immediate data) may be pushed directly to the NIC by the processor, obviating a memory read transaction by the NIC. Also, an embodiment enables a processor to directly manipulate descriptors and/or data stored on the NIC device, saving number of intermediate copies to the main memory for descriptors and/or network data. Further, one embodiment enables an interrupt-free architecture since accesses to the NIC registers (such as CSRs) are coherent and have low latency.

FIG. 5 illustrates a block diagram of a computing system 500 in accordance with an embodiment of the invention. The computing system 500 may include one or more central processing unit(s) (CPUs) or processors 502-1 through 502-P (which may be referred to herein as “processors 502” or “processor 502”). The processors 502 may communicate via an interconnection network (or bus) 504. The processors 502 may include a general purpose processor, a network processor (that processes data communicated over the computer network 102), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, various operations discussed herein, e.g., with reference to FIGS. 1-4 may be performed by one or more components of the system 500.

A chipset 506 may also communicate with the interconnection network 504. The chipset 506 may include a graphics memory control hub (GMCH) 508. The GMCH 508 may include a memory controller 510 that communicates with a memory 512. The memory 512 may store data, including sequences of instructions that are executed by the processor 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The GMCH 508 may also include a graphics interface 514 that communicates with a graphics accelerator 516. In one embodiment of the invention, the graphics interface 514 may communicate with the graphics accelerator 516 via an accelerated graphics port (AGP). In an embodiment of the invention, a display (such as a flat panel display, a cathode ray tube (CRT), a projection screen, etc.) may communicate with the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 518 may allow the GMCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the processor 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and one or more network adapter(s) 530 (which is in communication with the computer network 102 and may comply with one or more of the various types of communication protocols discussed with reference to FIG. 1). Moreover, the network adapter 530 may be coupled to a coherent bus as discussed with reference to FIGS. 1-4. Accordingly, the bus 522 may be a coherent bus that allows coherent communication with other components coupled to the bus 522 and/or bus 504. To this end, in one embodiment, the chipset 506 may include logic to allow for the buses 522 and 504 to operate in a coherent manner. Other devices may communicate via the bus 522. Also, various components (such as the network adapter 530) may communicate with the GMCH 508 in some embodiments of the invention. In addition, the processor 502 and the GMCH 508 may be combined to form a single chip. Furthermore, the graphics accelerator 516 may be included within the GMCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration. For example, processors, memory, and/or input/output devices may be interconnected by a number of point-to-point interfaces.

As illustrated in FIG. 5, the memory 512 may include one or more of an operating system(s) (O/S) 532 or application(s) 534. The memory 512 may also store one or more device driver(s) 535 (such as the “software” discussed with reference to FIGS. 1-4), packet buffers, descriptors 536 (such as those discussed with reference to FIGS. 1-4), protocol driver(s), etc. (not shown) to facilitate communication over the network 102. Programs and/or data in the memory 512 may be swapped into the disk drive 528 as part of memory management operations. The application(s) 534 may execute (on the processor(s) 502) to communicate one or more packets with one or more computing devices coupled to the network 102 (such as the devices 104-106 of FIG. 1). In an embodiment, a packet may be a sequence of one or more symbols and/or values that may be encoded by one or more electrical signals transmitted from at least one sender to at least on receiver (e.g., over a network such as the network 102). For example, each packet may include a header that includes various information which may be utilized in routing and/or processing the packet, such as a source address, a destination address, packet type, etc. Each packet may also have a payload that includes the raw data (or content) the packet is transferring between various computing devices (e.g., the devices 104-106 of FIG. 1) over a computer network (such as the network 102).

In an embodiment, the application 534 may utilize the O/S 532 to communicate with various components of the system 500, e.g., through a device driver 535. Hence, the device driver 535 may include network adapter 530 specific commands to provide a communication interface between the O/S 532 and the network adapter 530. Furthermore, in some embodiments, the network adapter 530 may include a (network) protocol layer for implementing the physical communication layer to send and receive network packets to and from remote devices over the network 102. The network 102 may include any type of computer network such as those discussed with reference to FIG. 1. The network adapter 530 may further include a DMA engine (such as the DMA engines discussed with reference to FIGS. 2-4), which may write packets to buffers assigned to available descriptors in the memory 512. Additionally, the network adapter 530 may include a network adapter controller 554, which may include hardware (e.g., logic circuitry) and/or a programmable processor to perform adapter related operations. In an embodiment, the adapter controller 554 may be a MAC (media access control) component. The network adapter 530 may further include a memory 556, such as any type of volatile/nonvolatile memory, and may include one or more cache(s). In an embodiment, components of the system 500 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-5, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include any type of a storage device, including those discussed herein, for example.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a network interface card (NIC) to transmit and receive data packets over a network; and
one or more processors coupled to the NIC through a coherent interconnection,
wherein the NIC comprises a plurality of buffers that are accessible by the one or more processors via the coherent interconnection to allow the one or more processors to access data stored in the plurality of buffers prior to moving the data to another memory.

2. The apparatus of claim 1, wherein the NIC comprises one or more registers that are mapped to corresponding system addresses, wherein the system addresses are accessible by the one or more processors.

3. The apparatus of claim 2, wherein the memory is coupled to the interconnection and wherein the system addresses correspond to addresses of locations within the memory.

4. The apparatus of claim 2, wherein the one or more processors write transmit data directly to the system addresses to cause transmission of the transmit data over the network.

5. The apparatus of claim 4, wherein the one or more processors are to write transmit data directly to the system addresses if a transmit descriptor indicates immediate data transmission is to occur.

6. The apparatus of claim 2, wherein the one or more processors read received data directly from the system addresses.

7. The apparatus of claim 1, further comprising a chipset coupled between the one or more processors and the NIC.

8. The apparatus of claim 1, where the NIC comprises one or more direct memory access (DMA) engines to perform a DMA for the data packets.

9. The apparatus of claim 1, wherein at least one of the one or more processors comprises a plurality of processor cores.

10. A method comprising:
storing data in one or more buffers of a network interface card (NIC);
accessing the stored data by one or more processors coupled to the NIC through a coherent interconnection,
wherein the one or more buffers are accessible by the one or more processors via the coherent interconnection to allow the one or more processors to access the stored data in the one or more buffers prior to moving the data to a memory.

11. The method of claim 10, further comprising mapping one or more registers of the NIC to corresponding system addresses, wherein the system addresses are directly accessible by the one or more processors.

12. The method of claim 11, further comprising the one or more processors writing transmit data directly to the system addresses to cause transmission of the transmit data over a network.

13. The method of claim 10, further comprising transferring the stored data without a direct memory access (DMA) operation if a transmit descriptor of the stored data is an immediate data descriptor.

14. The method of claim 10, further comprising updating one or more pointers of the one or more buffers after communication of the stored data.

15. The method of claim 14, wherein the one or more pointers comprise a head pointer or a tail pointer.
